(19) United States
(12) Patent Application Publication
(10) Pub. No.: US 2018/0286388 A1
(43) Pub. Date: Oct. 4, 2018

(54) CONFERENCE SUPPORT SYSTEM, CONFERENCE SUPPORT METHOD, PROGRAM FOR CONFERENCE SUPPORT DEVICE, AND PROGRAM FOR TERMINAL

(71) Applicant: HONDA MOTOR CO., LTD., Tokyo (JP)

(72) Inventors: Takashi Kawachi, Wako-shi (JP); Kazuhiro Nakadai, Wako-shi (JP); Tomoyuki Sahata, Tokyo (JP); Syota Mori, Hayami-gun (JP); Yasumasa Okuda, Usa-shi (JP); Kazuya Maura, Hayami-gun (JP)

(21) Appl. No.: 15/934,367

(22) Filed: Mar. 23, 2018

(30) Foreign Application Priority Data
Mar. 31, 2017 (JP) 2017-071189

(51) Int. Cl. G10L 15/18; H04L 29/06; G10L 15/22; G10L 15/26; G06F 17/27

(52) U.S. Cl. CPC G10L 15/18; H04L 65/403; G06F 17/2765; G10L 15/265; G10L 15/22

(57) ABSTRACT

A conference support system includes a plurality of terminals which are respectively used by a plurality of participants in a conference, and a conference support device. Each of the plurality of terminals includes an operation unit that sets uttering intention, and an own utterance notifying unit that notifies the other terminals of information indicating the uttering intention.

### CROSS-REFERENCE TO RELATED APPLICATION

Priority is claimed on Japanese Patent Application No. 2017-071189, filed Mar. 31, 2017, the content of which is incorporated herein by reference.

### BACKGROUND OF THE INVENTION

### Field of the Invention

The present invention relates to a conference support system, a conference support method, a program for a conference support device, and a program for a terminal.

### Description of Related Art

In a case where a plurality of persons participate in a conference, it has been suggested that utterance contents of each utterer be converted into text, and the text be displayed on a reproduction device possessed by each user (for example, refer to Japanese Unexamined Patent Application, First Publication No. H8-194492 (hereinafter, referred to as “Patent Literature 1”). Furthermore, in the technology described in Patent Literature 1, an utterance is recorded as a voice memo for every subject, and a person who prepares the minutes reproduces the voice memo that is recorded and converts the voice memo into text. In addition, in the technology described in Patent Literature 1, text that is created is correlated with another text for structuration, thereby preparing the minutes. The prepared minutes are displayed with a reproduction device.

### SUMMARY OF THE INVENTION

However, when a plurality of persons simultaneously start utterance, it may be difficult to display utterance contents as text for every utterer. Accordingly, there is a possibility that for example, a hearing-impaired person and the like cannot recognize who is an utterer even seeing contents displayed as text.

In addition, in a case of text obtained through input of an utterance, when a plurality of texts are simultaneously input, there is a possibility that a participant cannot recognize who an utterer is even seeing the text that is displayed.

Aspects of the invention have been made in consideration of the above-described problem, and an object thereof is to provide a conference support system, a conference support method, a program for a conference support device, and a program for a terminal which are capable of preventing a plurality of utterers from simultaneously uttering.

To accomplish the object, the invention employs the following aspects.

(1) According to an aspect of the invention, a conference support system is provided, including: a plurality of terminals which are respectively used by a plurality of participants in a conference; and a conference support device. Each of the plurality of terminals includes an operation unit that sets uttering intention, and an own utterance notifying unit that notifies the other terminals of information indicating the uttering intention.

(2) According to another aspect of the invention, a conference support system is provided, including: a plurality of terminals which are respectively used by a plurality of participants in a conference; and a conference support device. The conference support device includes a processing unit that does not permit utterance from the terminals other than a terminal from which information indicating uttering intention of one of the plurality of participants is received. Each of the plurality of terminals includes an operation unit that sets information indicating uttering intention, and an own utterance notifying unit that transmits the information indicating the uttering intention to the conference support device.

(3) In the conference support system according to the aspect (1) or (2), the own utterance notifying unit of the terminal may transmit information indicating termination of the utterance to the conference support device when the utterance is terminated.

(4) In the conference support system according to any one of the aspects (1) to (3), when receiving information indicating uttering intention of the plurality of participants from the plurality of terminals, a processing unit of the conference support device may set an utterer on the basis of a priority that is set in advance.

(5) In the conference support system according to any one of the aspects (1) to (4), after receiving information indicating uttering intention of one of the plurality of participants, when receiving information indicating uttering intention of the other participants from the other terminals, the processing unit of the conference support device may issue an alarm indicating that another participant is in utterance.

(6) In the conference support system according to any one of the aspects (1) to (5), the conference support device may include an acquisition unit that acquires utterance and determines whether a content of the utterance is either voice information or text information, and a voice recognition unit that recognizes the voice information, and converts the voice information into text information in a case where the content of utterance is voice information.

(7) According to another aspect of the invention, a conference support method in a conference support system is provided, including a plurality of terminals which are respectively used by a plurality of participants in a conference. The method includes: allowing an operation unit of each of the plurality of terminals to set uttering intention; and allowing an own utterance notifying unit of the terminal to notify the other terminals of information indicating the uttering intention.

(8) According to another aspect of the invention, a conference support method in a conference support system is provided, including a plurality of terminals which are respectively used by a plurality of participants in a conference, and a conference support device. The method includes: allowing an operation unit of each of the plurality of terminals to set information indicating uttering intention; allowing an own utterance notifying unit of the terminal to transmit the information indicating the uttering intention to the conference support device; and allowing a processing unit of the conference support device not to permit utterance from the terminals other than a terminal from which information indicating uttering intention of one of the plurality of participants is received.

(9) According to another aspect of the invention, a program for a conference support device in a conference support system is provided, including a plurality of terminals which are respectively used by a plurality of participants in a conference, and the conference support device. The program allows a computer of the conference support device to execute: receiving information indicating uttering intention of each of the plurality of participants; determining whether or not reception of the information indicating the uttering intention of one participant from one terminal and reception of the information indicating the uttering intention of the other participants from the other terminals overlap each other; and not-permitting the utterance from the other terminals in a case where the receptions overlap.

(10) According to another aspect of the invention, a program for a terminal in a conference support system is provided, including a plurality of the terminals which are respectively used by a plurality of participants in a conference, and a conference support device. The program allows a computer of the terminal to execute: setting information indicating uttering intention; and transmitting the information indicating the uttering intention to the conference support device.

According to the aspects (1), (2), (7), (8), (9), and (10), the uttering intention is given in a notification, and thus it is possible to prevent a plurality of utterers from simultaneously uttering.

According to the aspect (3), utterance termination is given in a notification, and thus it is possible to notify other persons of utterance termination.

According to the aspect (4), in a case where utterance initiation is requested from a plurality of persons, an utterer is set on the basis of a priority that is set in advance, and thus it is possible to prevent the plurality of persons from simultaneously uttering.

According to the aspect (5), in a case where utterers overlap each other, an alarm is issued, and thus it is possible to prevent the plurality of persons from simultaneously uttering.

According to the aspect (6), even when utterance is text information, it is possible to prevent the plurality of utterers from simultaneously uttering.

### BRIEF DESCRIPTION OF THE DRAWINGS

FIG. 1 is a block diagram illustrating a configuration example of a conference support system according to a first embodiment;

FIG. 2 is a view illustrating an example of an image that is displayed on a display unit of a terminal according to the first embodiment;

FIG. 3 is a view illustrating an example of an image that is displayed on the display unit of the terminal in a case where utterance initiation requests overlap each other according to the first embodiment;

FIG. 4 is a view illustrating an example of a priority that is determined in advance according to the first embodiment;

FIG. 5 is a sequence diagram of a procedure example of a conference support system according to the first embodiment;

FIG. 6 is a flowchart illustrating a procedure example that is executed by a terminal according to the first embodiment;

FIG. 7 is a flowchart illustrating a procedure example that is executed by the conference support device according to the first embodiment;

FIG. 8 is a view illustrating an example of an alarm that is displayed on a display unit of the terminal in a case where utterance is not permitted on the basis of the priority according to the first embodiment;

FIG. 9 is a view illustrating an example of an alarm that is displayed on the display unit of the terminal in a case where utterance is permitted on the basis of the priority according to the first embodiment; and

FIG. 10 is a flowchart illustrating a procedure example that is executed by the conference support device on the basis of the priority in a case where utterance initiation requests overlap each other according to the first embodiment.

### DETAILED DESCRIPTION OF THE INVENTION

Hereinafter, an embodiment of the invention will be described with reference to the accompanying drawings.

First, description will be given of a situation example in which a conference support system of this embodiment is used.

The conference support system of this embodiment is used in a conference that is performed in a state in which two or more persons participate in the conference. Among participants, a person who is inconvenient in utterance may participate in the conference. Each of utterable participants wears a microphone. In addition, the participants may carry a terminal (a smart phone, a tablet terminal, a personal computer, and the like). The conference support system performs voice recognition and conversion into text with respect to voice signals uttered by the participants, and displays the text on the terminal.

In addition, when performing utterance, a user initiates the utterance after operating a terminal, and operates the terminal after the utterance is terminated. The terminal transmits an utterance initiation request indicating initiation of the utterance and an utterance termination request indicating termination of the utterance to the conference support device for notification. A conference support device of the conference support system determines permission and non-permission of utterance on the basis of the utterance initiation request and the utterance termination request which are received from the terminal.

### First Embodiment

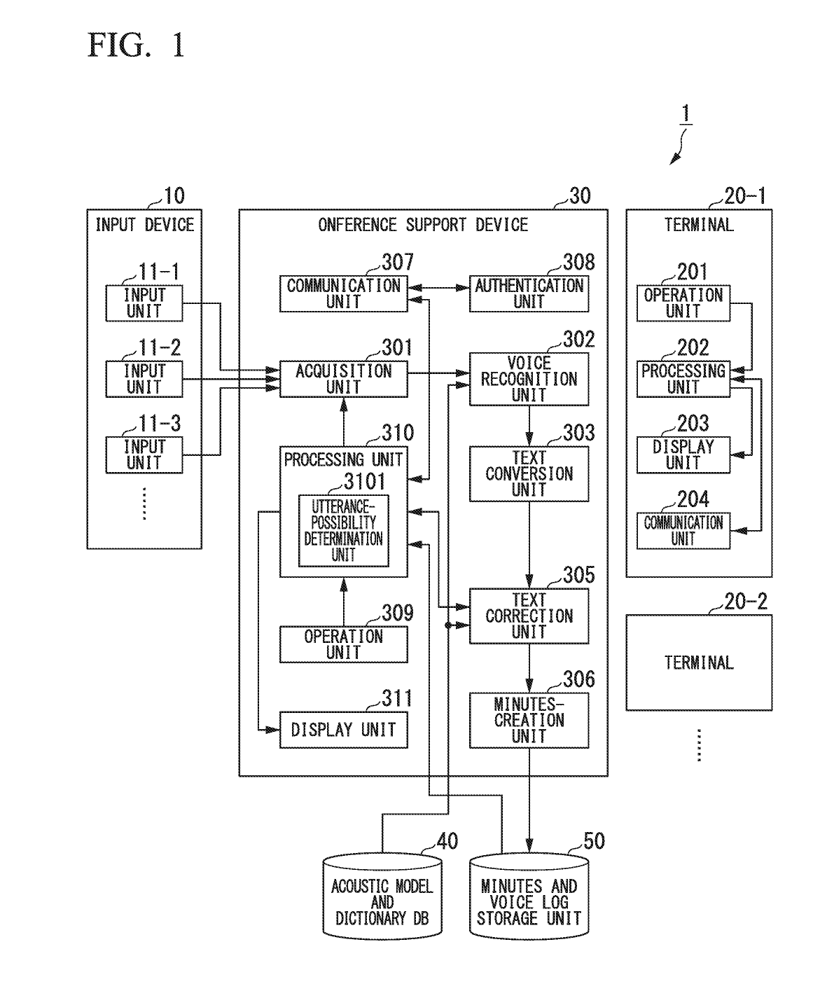

FIG. 1 is a block diagram illustrating a configuration example of a conference support system 1 according to this embodiment.

First, description will be given of a configuration of the conference support system 1.

As illustrated in FIG. 1, the conference support system 1 includes an input device 10, a terminal 20, a conference support device 30, an acoustic model and dictionary DB 40, and a minutes and voice log storage unit 50. In addition, the terminal 20 includes a terminal 20-1, a terminal 20-2, . . . . In a case of not specifying one of the terminal 20-1 and the terminal 20-2, the terminals are collectively referred to as “terminal 20”.

The input device 10 includes an input unit 11-1, an input unit 11-2, an input unit 11-3, . . . . In a case of not specifying one of the input unit 11-1, the input unit 11-2, the input unit 11-3, . . . , the input units are collectively referred to as “input unit 11”.

The terminal 20 includes an operation unit 201, a processing unit 202 (own utterance notifying unit), a display unit 203, and a communication unit 204 (own utterance notifying unit).

The conference support device 30 includes an acquisition unit 301, a voice recognition unit 302, a text conversion unit 303 (voice recognition unit), a text correction unit 305, a minutes-creation unit 306, a communication unit 307, an authentication unit 308, an operation unit 309, a processing unit 310, and a display unit 311.

The input device 10 and the conference support device 30 are connected to each other in a wired manner or a wireless manner. The terminal 20 and the conference support device 30 are connected to each other in a wired manner or a wireless manner. The processing unit 310 includes an utterance-possibility determination unit 3101.

First, description will be given of the input device 10.

The input device 10 outputs a voice signal, which is uttered by a user, to the conference support device 30. Furthermore, the input device 10 may be a microphone array. In this case, the input device 10 includes P pieces of microphones which are respectively disposed at positions different from each other. In addition, the input device 10 generates P-channel voice signals (P is an integer of two or greater) from sound that is acquired, and outputs the generated P-channel voice signals to the conference support device 30.

The input unit 11 is a microphone. The input unit 11 acquires voice signals of the user, converts the acquired voice signals from analog signals to digital signals, and outputs the voice signals, which are converted into the digital signals, to the conference support device 30. Furthermore, the input unit 11 may output the voice signals which are analog signals to the conference support device 30. Furthermore, the input unit 11 may output the voice signals to the conference support device 30 through a wired cord or cable, or may wirelessly transmit the voice signals to the conference support device 30.

Next, description will be given of the terminal 20.

Examples of the terminal 20 include a smart phone, a table terminal, a personal computer, and the like. The terminal 20 may include a voice output unit, a motion sensor, a global positioning system (GPS), and the like.

The operation unit 201 detects an operation by a user, and outputs a detection result to the processing unit 202. Examples of the operation unit 201 include a touch panel type sensor or a keyboard which is provided on the display unit 203.

The processing unit 202 generates transmission information in correspondence with the operation result output from the operation unit 201, and outputs the transmission information, which is generated, to the communication unit 204. The transmission information is one of a participation request indicating desire to participate in a conference, a leaving request indicating desire to leave the conference, an utterance initiation request indicating uttering intention initiation, an utterance termination request indicating utterance termination, an instruction for reproduction of the minutes in past conference, and the like. Furthermore, the transmission information includes identification information for identification of the terminal 20. As described above, before a participant initiates utterance, the processing unit 202 transmits the utterance initiation request to the conference support device 30 through the communication unit 204 for notification. In addition, in a case where the participant terminates the utterance, the processing unit 202 transmits the utterance termination request to the conference support device 30 through the communication unit 204 for notification.

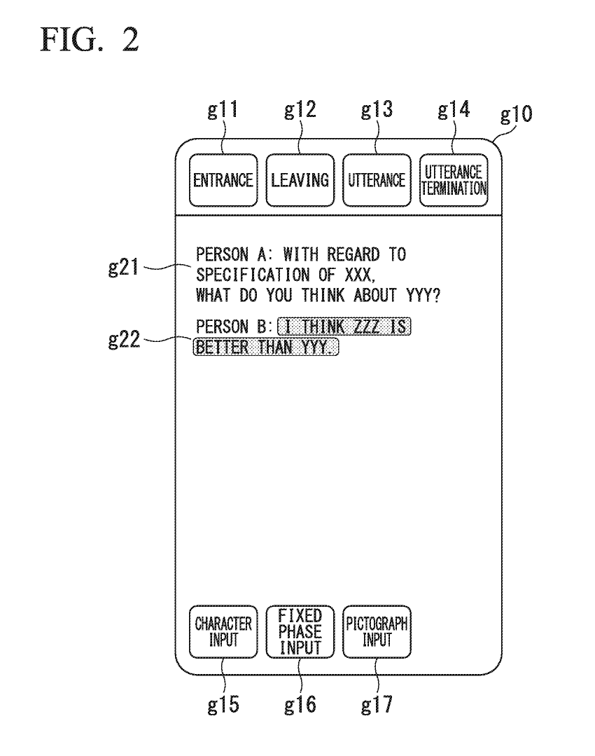

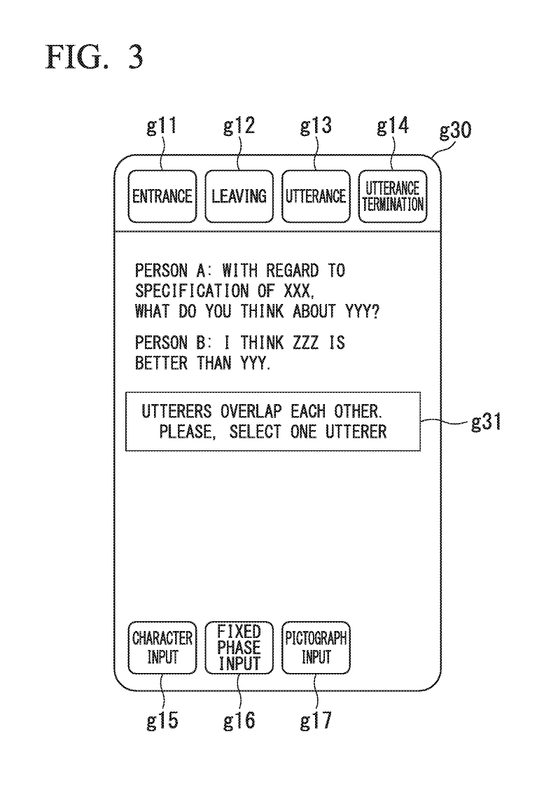

The processing unit 202 acquires the text information output from the communication unit 204, converts the acquired text information into image data, and outputs the converted image data to the display unit 203. Furthermore, the image displayed on the display unit 203 will be described later with reference to FIG. 2 and FIG. 3.

The display unit 203 displays the image data that is output from the processing unit 202. Examples of the display unit 203 include a liquid crystal display device, an organic electroluminescence (EL) display device, an electronic ink display device, and the like.

The communication unit 204 receives text information or information of the minutes from the conference support device 30, and outputs the reception information, which is received, to the processing unit 202. The communication unit 204 transmits instruction information output from the processing unit 202 to the conference support device 30.

Next, description will be given of the acoustic model and dictionary DB 40.

For example, an acoustic model, a language model, a word dictionary, and the like are stored in the acoustic model and dictionary DB 40. The acoustic model is a model based on a feature quantity of sound, and the language model is a model of information of words and an arrangement type of the words. In addition, the word dictionary is a dictionary of a plurality of words, and examples thereof include a large-vocabulary word dictionary. Furthermore, the conference support device 30 may stores words and the like, which are not stored in the voice recognition dictionary 13, in the acoustic model and dictionary DB 40 for updating thereof.

Next, description will be given of the minutes and voice log storage unit 50.

The minutes and voice log storage unit 50 stores the minutes (included voice signals).

Next, description will be given of the conference support device 30.

For example, the conference support device 30 is any one of a personal computer, a server, a smart phone, a tablet terminal, and the like. Furthermore, in a case where the input device 10 is a microphone array, the conference support device 30 further includes a sound source localization unit, a sound source separation unit, and a sound source identification unit.

The conference support device 30 performs voice recognition of voice signals uttered by participants, for example, for every predetermined period, and converts the voice signals into text. In addition, the conference support device 30 transmits text information of utterance contents converted into text to each of a plurality of the terminals 20 of the participants. In addition, the conference support device 30 corrects text information so that text corresponding to an utterer in current utterance is displayed differently from text information when previous utterance is terminated. In addition, when receiving an utterance initiation request before utterance, the conference support device 30 determines utterance possibility in correspondence with whether or not an utterance initiation request is received from other terminals 20. In a case where utterance is permitted, voice signals are acquired from an input unit 11 corresponding to a terminal 20 from which the utterance initiation request is received as instruction information. Furthermore, the conference support device 30 stores a correlation between the terminal 20 and the input unit 11. When receiving the utterance termination request from the terminal 20 as instruction information after utterance termination, the conference support device 30 determines that utterance is terminated, and terminates acquisition of voice signals of a corresponding utterer.

The acquisition unit 301 acquires voice signals output from the input unit 11 and outputs the acquired voice signals to the voice recognition unit 302. Furthermore, in a case where the acquired voice signals are analog signals, the acquisition unit 301 converts the analog signals into digital signals, and outputs the voice signals, which are converted into the digital signals, to the voice recognition unit 302.

In a case where a plurality of the input units 11 exist, the voice recognition unit 302 performs voice recognition for every utterer who uses each of the input units 11.

The voice recognition unit 302 acquires the voice signals output from the acquisition unit 301. The voice recognition unit 302 detects a voice signal in an utterance section from the voice signals output from the acquisition unit 301. With regard to detection of the utterance section, for example, a voice signal that is equal to or greater than a predetermined threshold value is detected as the utterance section. Furthermore, the voice recognition unit 302 may perform detection of the utterance section by using other known methods. In addition, the voice recognition unit 302 detects the utterance section by using information indicating utterance initiation of an important comment transmitted from the terminals 20 and information indicating utterance termination of the important comment. The voice recognition unit 302 performs voice recognition with respect to the voice signal in the utterance section that is detected with reference to the acoustic model and dictionary DB 40 by using a known method. Furthermore, the voice recognition unit 302 performs voice recognition by using, for example, a method disclosed in Japanese Unexamined Patent Application, First Publication No. 2015-64554, and the like. The voice recognition unit 302 outputs recognition results and voice signals after the recognition to the text conversion unit 303. Furthermore, the voice recognition unit 302 outputs the recognition results and the voice signals, for example, in correlation with each sentence, each utterance section, or each utterer.

The text conversion unit 303 converts the recognition results output from the voice recognition unit 302 into text. The text conversion unit 303 outputs text information after the conversion, and the voice signals to the text correction unit 305. Furthermore, the text conversion unit 303 may perform the conversion into text after deleting interjections such as “ah”, “um”, “uh”, and “wow”.

The text correction unit 305 corrects display of the text information output from the text conversion unit 303 in correspondence with a correction instruction output from the processing unit 310 through correction of a font color, correction of a font size, correction of the kind of fonts, addition of an underline to a comment, application of a marker to the comment, and the like. The text correction unit 305 outputs the text information that is output from the text conversion unit 303, or the corrected text information to the processing unit 310. The text correction unit 305 outputs the text information and the voice signals, which are output from the text conversion unit 303, to the minutes-creation unit 306.

The minutes-creation unit 306 creates the minutes on the basis of the text information and the voice signals, which are output from the text correction unit 305, for every utterer. The minutes-creation unit 306 stores voice signals corresponding to the created minutes in the minutes and voice log storage unit 50. Furthermore, the minutes-creation unit 306 may create the minutes after deleting interjections such as “ah”, “um”, “uh”, and “wow”.

The communication unit 307 transmits and receives information to and from the terminals 20. The information, which is received from the terminals 20, includes a participation request, voice signals, instruction information (including information indicating an important comment), an instruction for reproduction of the minutes in past conference, and the like. In response to the participation request received from any one of the terminals 20, the communication unit 307 extracts, for example, identification information for identification of the terminal 20, and outputs the extracted identification information to the authentication unit 308. Examples of the identification information includes a serial number of the terminals 20, a media access control address (MAC address), an internet protocol (IP) address, and the like. In a case where the authentication unit 308 outputs a communication participation permitting instruction, the communication unit 307 performs communication with the terminal 20 that makes a request for participation in a conference. In a case where the authentication unit 308 outputs a communication participation not-permitting instruction, the communication unit 307 does not perform communication with the terminal 20 that makes a request for participation in a conference. The communication unit 307 extracts instruction information from information that is received, and outputs the extracted instruction information to the processing unit 310. The communication unit 307 transmits text information or corrected text information, which is output from the processing unit 310, to the terminal 20 that makes a request for participation in a conference. The communication unit 307 transmits information of the minutes, which is output from the processing unit 310, to the terminal 20 that makes a request for participation in a conference.

The authentication unit 308 receives the identification information output from the communication unit 307 and determines whether or not to permit communication. Furthermore, for example, the conference support device 30 receives registration of a terminal 20 that is used by a participant in a conference, and registers the terminal 20 in the authentication unit 308. The authentication unit 308 outputs a communication participation permitting instruction or a communication participation not-permitting instruction to the communication unit 307 in correspondence with the determination result.

Examples of the operation unit 309 include a keyboard, a mouse, a touch panel sensor provided on the display unit 311, and the like. The operation unit 309 detects an operation result by a user and outputs a detected operation result to the processing unit 310.

The processing unit 310 transmits information indicating whether or not to permit utterance to a terminal 20, from which an utterance initiation request is transmitted, through the communication unit 307 in correspondence with a result of determination by the utterance-possibility determination unit 3101. Furthermore, in a case where utterance is permitted, the processing unit 310 may not transmit information indicating utterance permission to the terminal 20, from which the utterance initiation request is transmitted, through the communication unit 307. In a case where utterance is permitted, the processing unit 310 controls the acquisition unit 301 to acquire voice signals from the input unit 11 that is correlated with the terminal 20 for which utterance is permitted.

When simultaneously receiving the utterance initiation request from a plurality of terminals 20, the processing unit 310 output a correction instruction to the text correction unit 305 to display an alarm indicating utterance non-permission in correspondence with determination by the utterance-possibility determination unit 3101. According to this, the processing unit 310 transmits text information including the alarm corrected by the text correction unit 305 to the entirety of terminals 20, from which the utterance initiation request is transmitted, through the communication unit 307 for notification. In addition, the processing unit 310 may transmit only an alarm to the terminals 20 for notification.

In addition, when simultaneously receiving the utterance initiation request from the plurality of terminals 20, the processing unit 310 transmits information indicating utterance permission to a terminal 20, for which utterance permission is determined in accordance with a priority, in correspondence with determination by the utterance-possibility determination unit 3101. When simultaneously receiving the utterance initiation request from the plurality of terminals 20, the processing unit 310 transmits information indicating utterance non-permission to a terminal 20, for which utterance non-permission is determined in accordance with the priority, in correspondence with the determination by the utterance-possibility determination unit 3101

The processing unit 310 outputs text information or corrected text information, which is output from the text correction unit 305, to the communication unit 307.

The processing unit 310 reads out the minutes from the minutes and voice log storage unit 50 in correspondence with instruction information, and outputs information of the read-out minutes to the communication unit 307. Furthermore, the information of the minutes includes information indicating an utterer, information indicating a correction result by the text correction unit 305, and the like.

In a case where the utterance initiation request is included in the instruction information output from the communication unit 307, the utterance-possibility determination unit 3101 extracts identification information from the instruction information. The utterance-possibility determination unit 3101 determines possibility of utterance on the basis of the utterance initiation request that is received. In a case where the utterance initiation request is not simultaneously received from the plurality of terminals 20, the utterance-possibility determination unit 3101 permits utterance of a terminal 20 corresponding to the identification information that is extracted. When simultaneously receiving the utterance initiation request from the plurality of terminals 20, the utterance-possibility determination unit 3101 does not permit utterance of terminals 20 corresponding to a plurality of pieces of extracted identification information. The utterance-possibility determination unit 3101 does not permit utterance before receiving an utterance termination request included in the instruction information output from the communication unit 307 even when receiving the utterance initiation request from the other terminals 20.

When simultaneously receiving the utterance initiation request from the plurality of terminals 20, the utterance-possibility determination unit 3101 does not permit utterance of the entirety of terminals 20 from which the utterance initiation request is received. In addition, when simultaneously receiving the utterance initiation request from the plurality of terminals 20, the utterance-possibility determination unit 3101 determines a terminal 20, for which utterance is permitted, in accordance with a priority that is determined in advance.

The display unit 311 displays image data output from the processing unit 310. Examples of the display unit 311 include a liquid crystal display device, an organic EL display device, an electronic ink display device, and the like.

Furthermore, in a case where the input device 10 is a microphone array, the conference support device 30 further includes a sound source localization unit, a sound source separation unit, and a sound source identification unit. In this case, in the conference support device 30, the sound source localization unit performs sound source localization with respect to voice signals acquired by the acquisition unit 301 by using a transfer function that is created in advance. In addition, the conference support device 30 performs utterer identification by using results of the localization by the sound source localization unit. The conference support device 30 performs sound source separation with respect to the voice signals acquired by the acquisition unit 301 by using the results of the localization by the sound source localization unit. In addition, the voice recognition unit 302 of the conference support device 30 performs detection of an utterance section and voice recognition with respect to the voice signals which are separated from each other (for example, refer to Japanese Unexamined Patent Application, First Publication No. 2017-9657). In addition, the conference support device 30 may perform a reverberation sound suppressing process.

In addition, the conference support device 30 may perform morphological analysis and dependency analysis with respect to text information after conversion by the text conversion unit 303.

Next, description will be given of an example of an image that is displayed on the display unit 203 of each of the terminals 20 with reference to FIG. 2.

FIG. 2 is a view illustrating an example of an image that is displayed on the display unit 203 of the terminal 20 according to this embodiment.

First, description will be given of an image g10.

The image g10 is an image example that is displayed on the display unit 203 of the terminal 20 in utterance by a person B after utterance of a person A. The image g10 includes an entrance button image g11, a leaving button image g12, an utterance button image g13, an utterance termination button image g14, a character input button image g15, a fixed phase input button image g16, a pictograph input button image g17, an image g21 of an utterance text of the person A, and an image g22 of an utterance text of the person B.

The entrance button image g11 is an image of a button that is selected when a participant participates in a conference.

The leaving button image g12 is an image of a button that is selected when the participant leaves from the conference or the conference is terminated.

The utterance button image g13 is an image of a button that is selected in a case of initiating utterance.

The utterance termination button image g14 is an image of a button that is selected in a case of terminating a comment.

The character input button image g15 is an image of a button that is selected in a case where the participant inputs characters by operating the operation unit 201 of the terminal 20 instead of utterance with a voice.

The fixed phase input button image g16 is an image of a button that is selected when the participant inputs a fixed phase by operating the operation unit 201 of the terminal 20 instead of utterance with a voice. Furthermore, when this button is selected, a plurality of fixed phases are selected, and the participant is selected from the plurality of fixed phases which are displayed. Furthermore, examples of the fixed phases include “good morning”, “good afternoon”, “today is cold”, “today is hot”, “may I go to the bathroom?”, “let's have a break time from now”, and the like.

The pictograph input button image g17 is an image of a button that is selected when the participant inputs a pictograph by operating the operation unit 201 of the terminal 20 instead of utterance with a voice.

The image g21 that is the utterance text of the person A is text information after the voice recognition unit 302 and the text conversion unit 303 process voice signals uttered by the person A.

The image g22 that is the utterance text of the person B is text information after the voice recognition unit 302 and the text conversion unit 303 process voice signals uttered by the person B.

In addition, the example illustrated in FIG. 2 is an example in which the person B selects the utterance button image g13 before utterance, utterance of the person B is permitted by the conference support device 30, and the person B performs utterance and the utterance of the person B is converted into text to be displayed.

According to this, the processing unit 310 of the conference support device 30 gives a correction instruction for the text correction unit 305 to correct text information in utterance to be different from display of text information after utterance termination. In response to the correction instruction output from the processing unit 310, the text correction unit 305 performs, for example, correction (change) of a font color, correction of a font size, addition of an underline, application of a marker, and the like with respect to text corresponding to utterance of the person B to be different from the text (image g21) after utterance termination.

The image g22 is an example in which text information is corrected by applying a marker to text corresponding to utterance of the person B.

In addition, in the example illustrated in FIG. 2, description has been given of an example of buttons displayed on the display unit 203, but the buttons may be physical buttons (operation unit 201).

Next, description will be given of an image that is displayed on the display unit 203 of the terminals 20 in a case where utterance initiation requests overlap each other.

FIG. 3 is a view illustrating an example of an image that is displayed on the display unit 203 of the terminals 20 in a case where utterance initiation requests overlap each other according to this embodiment.

An image g30 is an image example that is displayed on the display unit 203 of each of the terminals 20 in a case where the person B utters after the person A utters, and then at least two persons among participants simultaneously make a request for utterance initiation. The image g30 includes an alarm image g31 in addition to the image g10.

The example illustrated in FIG. 3 is an example in which since the requests for utterance initiation are simultaneously transmitted, the requests overlap each other, and thus the utterance-possibility determination unit 3101 of the conference support device 30 does not permit utterance with respect to the entirety of participants who make a request. Accordingly, the utterance-possibility determination unit 3101 gives a correction instruction for the text correction unit 305 to correct text information for display of an alarm. According to this, the processing unit 310 of the conference support device 30 transmits information indicating an alarm to the entirety of terminals 20, which transmits the utterance initiation request, through the communication unit 307. As a result, the alarm image g31 is displayed on the display unit 203 of the terminals 20. Furthermore, examples of the alarm image g31 include “utterers overlap each other. Please, select one utterer”. Participants who respectively carry the terminals 20, on which the above-described display is displayed, determine an utterance order, for example, by discussion.

As a result, according to this embodiment, in a case where utterance initiation requests overlap each other, an alarm is issued, and thus it is possible to prevent overlapping of utterance.

In the example illustrated in FIG. 3, description has been given of an example in which in a case where utterance initiation requests overlap each other, an alarm is issued, but the conference support device 30 may determine an utterer on the basis of a priority that is determined in advance.

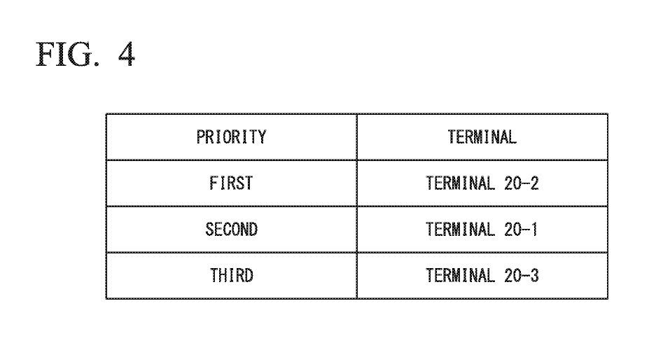

FIG. 4 is a view illustrating an example of the priority that is determined in advance according to this embodiment.

In the example illustrated in FIG. 4, the first priority is set to the terminal 20-2, the second priority is set to the terminal 20-1, and the third priority is set to the terminal 20-3.

Furthermore, the setting is stored, for example, in the processing unit 310.

Next, description will be given of a procedure example of the conference support system 1.

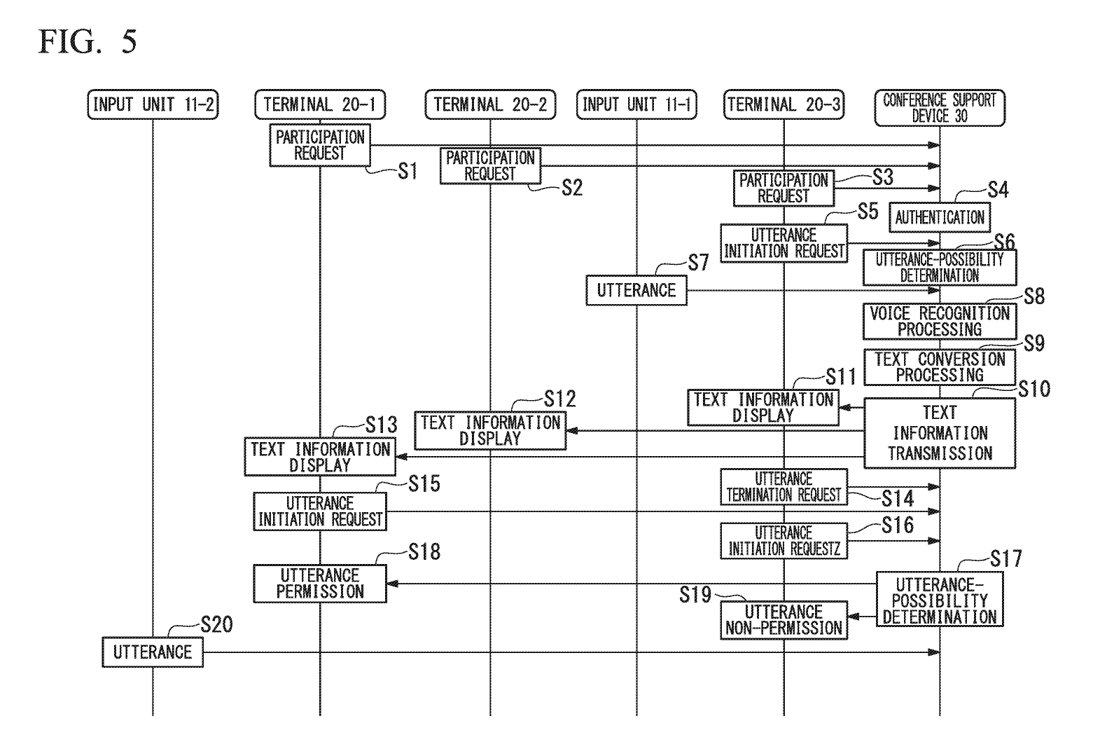

FIG. 5 is a sequence diagram of the procedure example of the conference support system 1 according to this embodiment.

The example illustrated in FIG. 5 is an example in which three participants (users) participate in a conference. A participant A is a user of the terminal 20-3 and wears the input unit 11-1. A participant B is a user of the terminal 20-1 and wears the input unit 11-2. A participant C is a user of the terminal 20-2 and is not wearing the input unit 11. For example, it is assumed that the participant B and the participant C are hearing-impaired persons such as a person who has difficulty in hearing. In addition, the example illustrated in FIG. 5 is an example in which an utterer is determined on the basis of a priority that is determined in advance in a case of simultaneously receiving an utterance initiation request.

(Step S1)

The user B selects the entrance button image g11 (FIG. 2) by operating the operation unit 201 of the terminal 20-1 to participate in a conference. The processing unit 202 of the terminal 20-1 transmits a participation request to the conference support device 30 in correspondence with a result in which the entrance button image g11 is selected by the operation unit 201.

(Step 2)

The participant C selects the entrance button image g11 by operating the operation unit 201 of the terminal 20-2 to participate in the conference. The processing unit 202 of the terminal 20-2 transmits a participation request to the conference support device 30 in correspondence with a result in which the entrance button image g11 is selected by the operation unit 201.

(Step 3)

The participant A selects the entrance button image g11 by operating the operation unit 201 of the terminal 20-3 to participate in a conference. The processing unit 202 of the terminal 20-3 transmits a participation request to the conference support device 30 in correspondence with a result in which the entrance button image g11 is selected by the operation unit 201.

(Step S4)

The communication unit 307 of the conference support device 30 receives the participation requests which are respectively transmitted from the terminal 20-1, the terminal 20-2, and the terminal 20-3. Subsequently, the communication unit 307 extracts, for example, identification information for identifying the terminals 20 from the participation requests received from the terminals 20.

Subsequently, the authentication unit 308 of the conference support device 30 receives the identification information output from the communication unit 307, and performs identification as to whether or not to permit communication. The example illustrated in FIG. 5 is an example in which participation of the terminal 20-1, the terminal 20-2, and the terminal 20-3 is permitted.

(Step S5)

The participant A operates the operation unit 201 of the terminal 20-3 before utterance to select the utterance button image g13 (FIG. 2). The processing unit 202 of the terminal 20-3 transmits an utterance initiation request to the conference support device 30 in correspondence with a result in which the utterance button image g13 is selected by the operation unit 201.

(Step S6)

The utterance-possibility determination unit 3101 of the conference support device 30 performs utterance-possibility determination. Specifically, in a case where the utterance initiation request is not received from other terminals 20, that is, other utterers are not in utterance, the utterance-possibility determination unit 3101 permits utterance. In addition, in a case where the utterance initiation request is received from other terminals 20, that is, other utterers are in utterance, the utterance-possibility determination unit 3101 does not permit utterance. Furthermore, in a case of permitting utterance, the processing unit 310 may not transmit information indicating utterance permission to a terminal 20 from which the utterance initiation request is transmitted. Furthermore, the utterance-possibility determination unit 3101 performs identification of the terminals 20 by using the identification information that is included in the utterance initiation request.

(Step S7)

The participant A performs utterance. The input unit 11-1 outputs voice signals to the conference support device 30.

(Step S8)

The voice recognition unit 302 of the conference support device 30 performs voice recognition processing with respect to the voice signals output from the input unit 11-1 (voice recognition processing).

(Step S9)

The text conversion unit 303 of the conference support device 30 converts the voice signals into text (text conversion processing).

(Step S10)

The processing unit 310 of the conference support device 30 transmits text information to each of the terminal 20-1, the terminal 20-2, and the terminal 20-3 through the communication unit 307.

(Step S11)

The processing unit 202 of the terminal 20-3 receives the text information, which is transmitted from the conference support device 30, through the communication unit 204, and displays the received text information on the display unit 203 of the terminal 20-3.

(Step S12)

The processing unit 202 of the terminal 20-2 receives text information, which is transmitted from the conference support device 30, through the communication unit 204, and displays the received text information on the display unit 203 of the terminal 20-2.

(Step S13)

The processing unit 202 of the terminal 20-1 receives text information, which is transmitted from the conference support device 30, through the communication unit 204, and displays the received text information on the display unit 203 of the terminal 20-1.

(Step S14)

After utterance termination, the participant A operates the operation unit 201 of the terminal 20-3 to select the utterance termination button image g14 (FIG. 2). The processing unit 202 of the terminal 20-3 transmits an utterance initiation request to the conference support device 30 in correspondence with a result in which the utterance termination button image g14 is selected by the operation unit 201.

(Step S15)

Before utterance, the participant B operates the operation unit 201 of the terminal 20-1 to select the utterance button image g13. The processing unit 202 of the terminal 20-1 transmits an utterance initiation request to the conference support device 30 in correspondence with a result in which the utterance button image g13 is selected by the operation unit 201.

(Step S16)

Before utterance, the participant A operates the operation unit 201 of the terminal 20-3 to select the utterance button image g13. The processing unit 202 of the terminal 20-3 transmits an utterance initiation request to the conference support device 30 in correspondence with a result in which the utterance button image g13 is selected by the operation unit 201.

(Step S17)

The utterance-possibility determination unit 3101 of the conference support device 30 performs utterance-possibility determination. The example illustrated in FIG. 5 is an example in which the conference support device 30 simultaneously receives utterance initiation requests from the terminal 20-1 and the terminal 20-3. Accordingly, the utterance-possibility determination unit 3101 determines that utterance is permitted for the terminal 20-1 and utterance is not permitted for the terminal 20-3 on the basis of the priority (FIG. 4) that is determined in advance.

(Step S18)

The processing unit 310 of the conference support device 30 transmits information indicating utterance permission to the terminal 20-1 through the communication unit 307.

(Step S19)

The processing unit 310 of the conference support device 30 transmits information indicating utterance non-permission to the terminal 20-3 through the communication unit 307.

(Step S20)

The participant B performs utterance. The input unit 11-2 outputs voice signals to the conference support device 30.

The processing of the conference support system 1 is terminated after the above-described steps.

As a result, according to this embodiment, in a case where utterance initiation requests overlap each other, utterance-possibility is determined on the basis of the priority that is determined in advance, and is given in a notification, and thus it is possible to prevent overlapping of utterance.

Next, description will be given of a procedure example that is executed by the terminals 20.

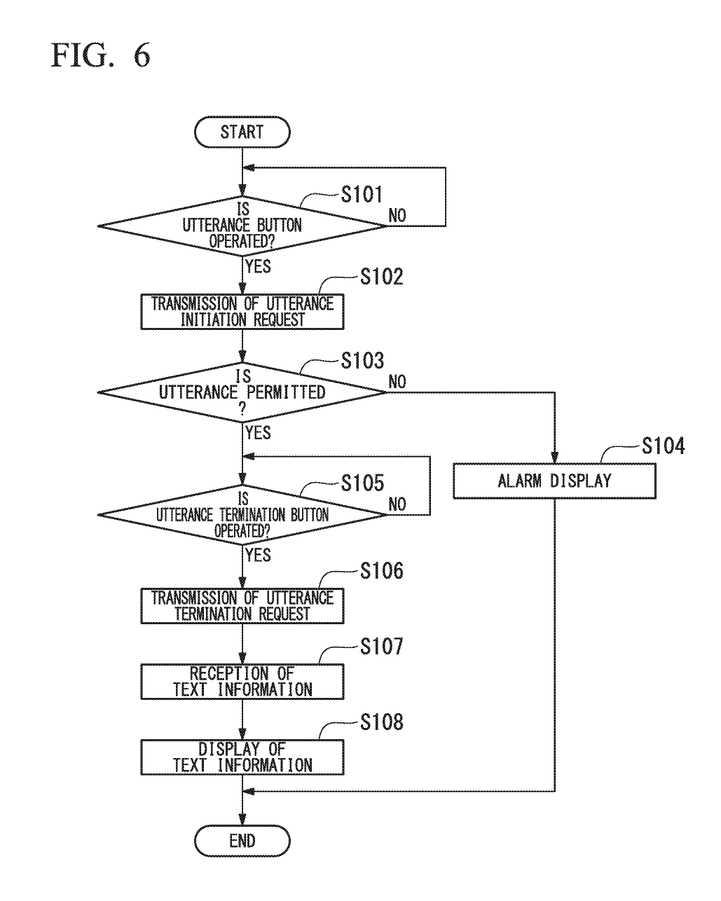

FIG. 6 is a flowchart illustrating the procedure example that is executed by the terminals 20 according to this embodiment.

(Step S101)

The processing unit 202 determines whether or not the operation unit 201 is operated and the utterance button image g13 (FIG. 2) is operated. In a case where it is determined that the utterance button is operated (YES in step S101), the processing unit 202 proceeds to processing in step S102. In a case where it is determined that the utterance button is not operated (NO in step S101), the processing unit 202 repeats the processing in step S101.

(Step S102)

The processing unit 202 transmits instruction information including the utterance initiation request to the conference support device 30 for notification. Furthermore, the utterance initiation request includes identification information of each of the terminals 20.

(Step S103)

In correspondence with transmission of the utterance initiation request, the processing unit 202 determines whether or not information indicating utterance permission is received from the conference support device 30 through the communication unit 307. In a case where it is determined that the information indicating the utterance permission is received (YES in step S103), the processing unit 202 proceeds to processing in step S105. In this case, a participant initiates utterance. Subsequently, the input device 10 outputs uttered voice signals to the conference support device 30. In addition, in a case where it is determined that information indicating utterance permission is not received (NO in step S103), the processing unit 202 proceeds to processing in step S104. In addition, even in a case where the information indicating utterance non-permission is not received from the conference support device 30 in a predetermined time after transmission of the utterance initiation request, the processing unit 310 may determine that information indicating speaking is permitted has been received.

(Step S104)

The processing unit 202 receives an alarm transmitted from the conference support device 30 through the communication unit 307. Subsequently, the processing unit 202 displays the received alarm on the display unit 203. After the processing, the processing unit 202 terminates the processing.

(Step S105)

The processing unit 202 determines whether or not the operation unit 201 is operated and the utterance termination button image g14 (FIG. 2) is operated. In a case where it is determined that the utterance termination button is operated (YES in step S105), the processing unit 202 proceeds to processing in step S106. In a case where it is determined that the utterance termination button is not operated (NO in step S105), the processing unit 202 repeats the processing in step S105.

(Step S106)

The processing unit 202 transmits instruction information including the utterance termination request to the conference support device 30 for notification. Furthermore, the utterance termination request includes identification information of each of the terminals 20.

(Step S107)

The processing unit 202 receives the text information or the text information after correction which is transmitted from the conference support device 30.

(Step S108)

The processing unit 202 displays the text information or the text information after correction, which is received, on the display unit 203.

The processing of each of the terminals 20 is terminated after the above-described steps.

Next, description will be given of a procedure example that is executed by the conference support device 30.

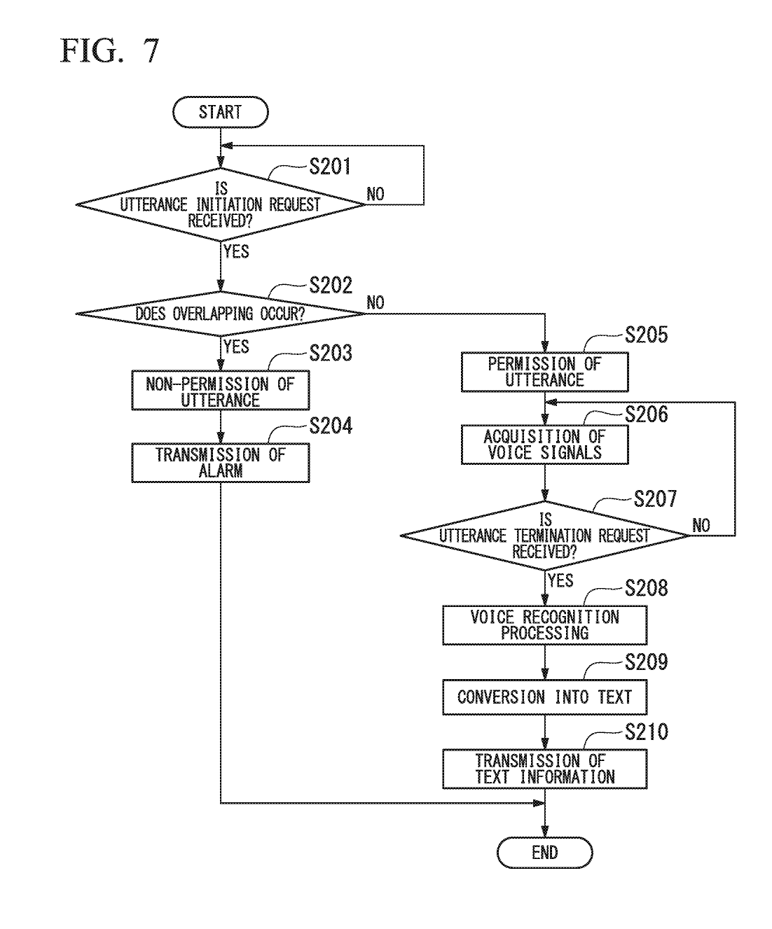

FIG. 7 is a flowchart illustrating a procedure example that is executed by the conference support device 30 according to this embodiment. Furthermore, the example illustrated in FIG. 7 is processing in which an alarm is issued in a case of simultaneously receiving utterance initiation requests from a plurality of terminals 20.

(Step S201)

The processing unit 310 determines whether or not instruction information including the utterance initiation request from the terminals 20 is received. In a case where it is determined that the instruction information is not received (NO in step S201), the processing unit 310 repeats the processing in step S201. In a case where it is determined that the instruction information is received (YES in step S201), the processing unit 310 proceeds to processing in step S202.

(Step S202)

In a case where the utterance initiation request is included in the instruction information output from the communication unit 307, the utterance-possibility determination unit 3101 extracts identification information from the instruction information. Subsequently, the utterance-possibility determination unit 3101 determines whether or not utterance initiation requests are simultaneously received from a plurality of terminals 20, that is, the utterance initiation requests overlap each other. In a case where it is determined that the utterance initiation requests overlap each other (YES in step S202), the utterance-possibility determination unit 3101 proceeds to processing in step S203, In a case where it is determined that the utterance initiation requests do not overlap each other (NO in step S202), the utterance-possibility determination unit 3101 proceeds to processing in step S205.

(Step S203)

When simultaneously receiving the utterance initiation requests from the plurality of terminals 20, the utterance-possibility determination unit 3101 does not permit utterance of each of the terminals 20 corresponding to a plurality of pieces of extracted identification information.

(Step S204)

The processing unit 310 transmits information indicating utterance non-permission, and information indicating an alarm to the terminals 20, from which the utterance initiation request is transmitted, through the communication unit 307. The processing unit 310 terminates the processing.

(Step S205)

The utterance-possibility determination unit 3101 permits utterance of a terminal 20 corresponding to identification information that is extracted. Subsequently, the processing unit 310 transmits information indicating utterance permission to the terminal 20, from which the utterance initiation request is transmitted, through the communication unit 307.

(Step S206)

The acquisition unit 301 acquires voice signals from the input unit 11 corresponding to the identification information that is extracted. Furthermore, the processing unit 310 stores a correlation between the terminal 20 and the input unit 11.

(Step S207)

The processing unit 310 determines whether or not instruction information including an utterance termination request is received from the terminal 20. In a case where it is determined that the instruction information is not received (NO in step S207), the processing unit 310 returns to the processing in step S206. In a case where it is determined that the instruction information is received (YES in step S207), the processing unit 310 proceeds to processing in step S208.

(Step S208)

The voice recognition unit 302 performs voice recognition processing with respect to voice signals which are acquired.

(Step S209)

The text conversion unit 303 converts utterance contents into text on the basis of a voice recognition result. After the processing, the text conversion unit 303 proceeds to processing in step S210.

(Step S210)

The processing unit 310 transmits the text information or the corrected text information to the entirety of terminals 20 which participate in a conference.

The processing that is executed by the conference support device 30 is terminated after the above-described steps.

In FIG. 3 and FIG. 7, description has been given of an example in which an alarm is transmitted to the entirety of terminals 20 from which utterance initiation requests are transmitted in a case where utterance initiation requests overlap each other. However, the conference support device 30 may determine an utterer on the basis of the priority as described above.

Next, description will be given of an example in which an utterer is determined on the basis of a priority.

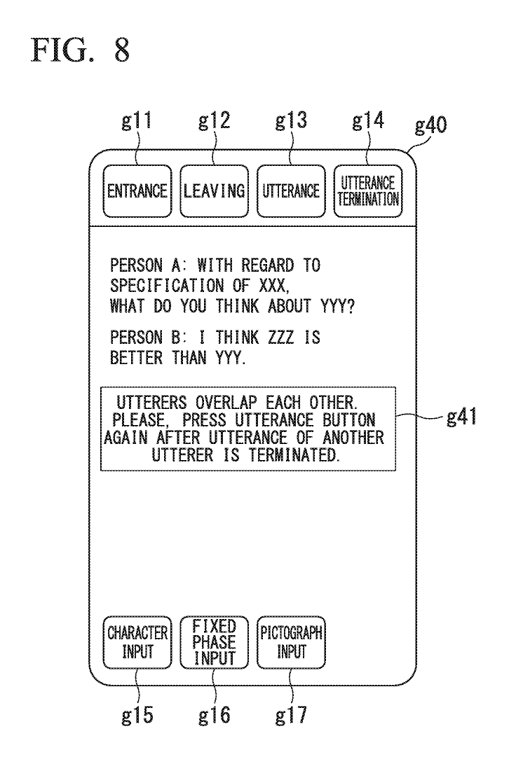

FIG. 8 is a view illustrating an example of an alarm that is displayed on the display unit 203 of each of the terminals 20 in a case where utterance is not permitted on the basis of the priority according to this embodiment.

An image g40 in FIG. 8 is an example in which the person B utters after utterance of the person A, and for example, a user of the terminal 20-1 selects the utterance button image g13. This example is also an example in which an utterance initiation request is simultaneously transmitted also from another terminal 20-2, and the priority of the other terminal 20-2 is high, and thus utterance is not permitted for the terminal 20-1 and the terminal 20-1 is notified of an alarm. In this case, as in the image g40, an alarm image g41, that is, “utters overlap each other. Please, press an utterance button again after utterance of another utterer is terminated” is displayed on the display unit 203. Furthermore, the alarm image g41 is illustrative only, and there is no limitation thereto.

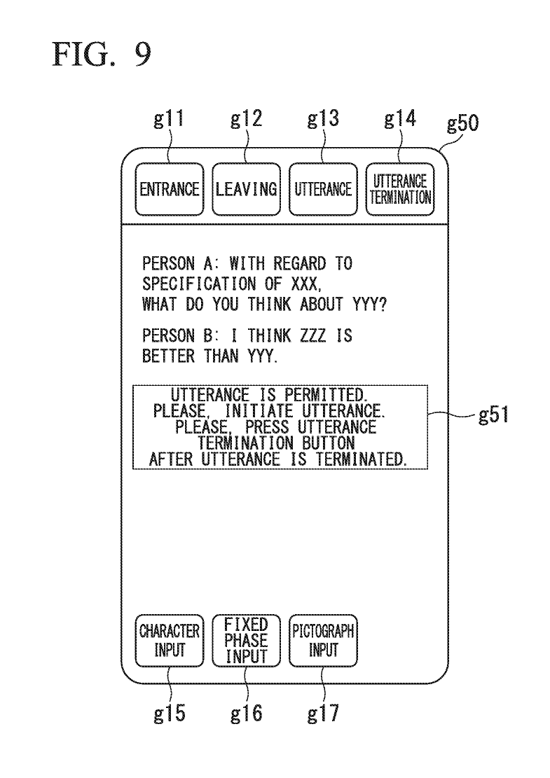

FIG. 9 is a view illustrating an example of an alarm that is displayed on the display unit 203 of each of the terminals 20 in a case where utterance is permitted on the basis of the priority according to this embodiment.

For example, an image g50 in FIG. 9 is an image that is displayed on the display unit 203 of the terminal 20-2 for which utterance is permitted in FIG. 8. The example is also an example in which the priority of the terminal 20-2 is higher than that of the other terminal 20-1, and thus utterance is permitted for the terminal 20-2. In this case, as in the image g50, an utterance permission image g51, that is, “utterance is permitted. Please, initiate utterance. Please, press an utterance termination button after utterance is terminated” is displayed on the display unit 203. Furthermore, the utterance permission image g51 is an illustration only, and there is no limitation thereto.

Next, description will be given of a procedure example that is executed by the conference support device 30 on the basis of the priority in a case where utterance initiation requests overlap each other.

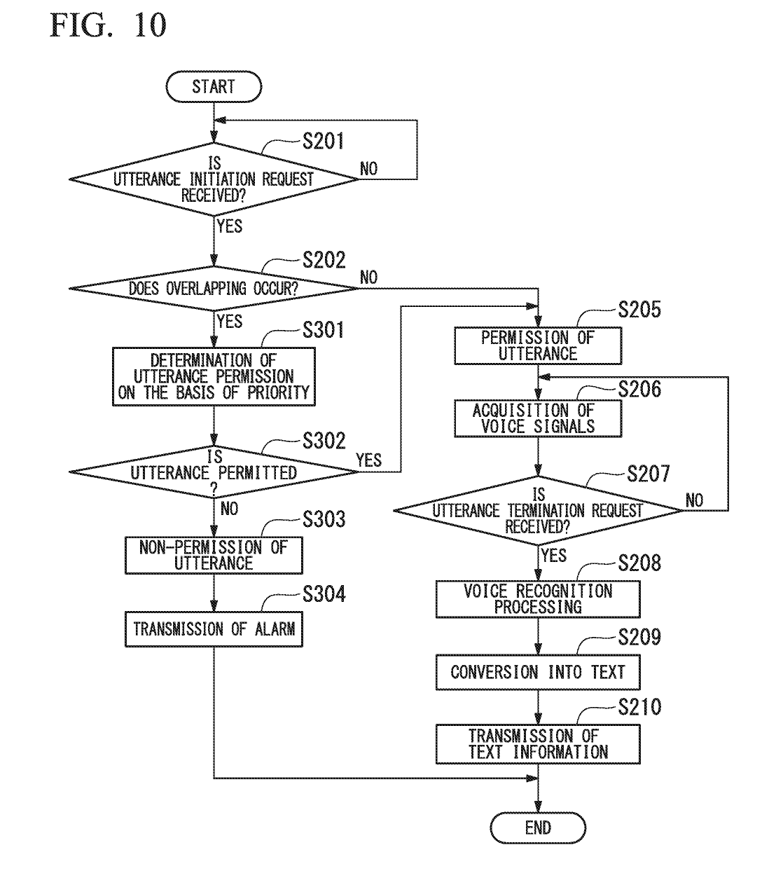

FIG. 10 is a flowchart illustrating a procedure example that is executed by the conference support device 30 on the basis of the priority in a case where utterance initiation requests overlap each other according to this embodiment. Furthermore, the same reference numerals will be used with respect to the processing as in FIG. 7, and description thereof will not be repeated.

(Step S201 to Step S202)

The processing unit 310 and the utterance-possibility determination unit 3101 perform the processing in step S201 and the processing in step S202. In a case where it is determined that utterance initiation requests overlap each other (YES in step S202), the utterance-possibility determination unit 3101 proceeds to processing in step S301. In a case where it is determined that the utterance initiation requests do not overlap each other (NO in step S202), the utterance-possibility determination unit 3101 proceeds to the processing in step S205.

(Step S301)

The utterance-possibility determination unit 3101 determines utterance-possibility on the basis of the priority (for example, FIG. 4) that is determined in advance.

(Step S302)

The utterance-possibility determination unit 3101 determines whether or not utterance permission is determined. In a case where it is determined that utterance is permitted (YES in step S302), the utterance-possibility determination unit 3101 proceeds to the processing in step S205. In a case where it is determined that utterance is not permitted (NO in step S302), the utterance-possibility determination unit 3101 proceeds to processing in step S303.

(Step S303)

In a case where utterance initiation requests are simultaneously received from a plurality of terminals 20, the utterance-possibility determination unit 3101 does not permit utterance of the terminals 20 corresponding to a plurality of pieces of extracted identification information.

(Step S304)

The processing unit 310 transmits information indicating utterance non-permission, and information indicating an alarm to the terminals 20, from which the utterance initiation request is transmitted, through the communication unit 307. The processing unit 310 terminates the processing.

Furthermore, the processing in step S205 to the processing in step S210 in a case where utterance is permitted are the same as those in FIG. 7.

Furthermore, even in a case of processing based on the priority, the processing of the terminals 20 is the same as described in FIG. 6.

Hereinbefore, in this embodiment, as illustrated in FIG. 2, FIG. 3, FIG. 8, and FIG. 9, the utterance (right of utterance) button and the utterance termination button are provided in the terminals 20. In addition, in this embodiment, when the utterance button is operated, in a case where overlapping of the right of utterance does not occur, the conference support device 30 permits utterance (gives the right of utterance). On the other hand, in this embodiment, in a case where overlapping of the right of utterance occurs, an utterer is determined on the basis of the priority that is determined in advance. In addition, in this embodiment, in a case where overlapping of the right of utterance occurs, an alarm is issued to the entirety of terminals 20 which desire to utter.

As described above, according to this embodiment, intention to own utterance is given in a notification, and thus it is possible to prevent a plurality of utterers from simultaneously uttering. According to this embodiment, particularly, it is possible to prevent a situation in which hearing-impaired persons and the like simultaneously utter, results of the utterance are displayed on the terminals 20, and recognition becomes difficult.

In addition, according to this embodiment, utterance termination is given in a notification, and thus it is possible to notify other persons of the utterance termination.

In addition, according to this embodiment, in a case where utterance initiation is requested by a plurality of persons, an utterer is set on the basis of the priority that is set in advance, and thus it is possible to prevent a plurality of persons from simultaneously uttering.

In addition, according to this embodiment, in a case where utterers overlap each other, an alarm is issued, and thus it is possible to prevent the plurality of persons from simultaneously uttering.

As described above, according to this embodiment, it is possible to prevent the plurality of persons from simultaneously uttering, and thus utterance contents can be displayed as text for every utterer. According to this, a hearing-impaired person can recognize who is an utterer with reference to contents displayed as text on the terminals 20.

Furthermore, in the above-described example, description has been given of an example in which conversion into Japanese text is performed in a case where utterance is in Japanese, but the text conversion unit 303 may translate the text into text of a language different from the uttered language by using a known translation method. In this case, a language that is displayed on each of the terminals 20 may be selected by a user of the terminal 20. For example, Japanese text information may be displayed on the display unit 203 of the terminal 20-1, and English text information may be displayed on the display unit 203 of the terminal 20-2.

### Second Embodiment

In the first embodiment, description has been given of an example in which a signal acquired by the acquisition unit 301 is a voice signal, but the information that is acquired may be text information. This case will be described with reference to FIG. 1.

The input unit 11 is a microphone or a keyboard (including a touch panel type keyboard). In a case where the input unit 11 is a microphone, the input unit 11 acquires a voice signal of a participant, converts the acquired voice signal from an analog signal to a digital signal, and outputs the voice signal, which is converted into a digital signal, to the conference support device 30. In a case where the input unit 11 is a keyboard, the input unit 11 detects an operation of a participant, and outputs text information of a detected result to the conference support device 30. In a case where the input unit 11 is a keyboard, the input unit 11 may be the operation unit 201 of the terminals 20. Furthermore, the input unit 11 may output the voice signals or the text information to the conference support device 30 through a wired cord or cable, or may wirelessly transmit the voice signals or the text information to the conference support device 30. In a case where the input unit 11 is the operation unit 201 of the terminals 20, for example, as illustrated in FIG. 4, a participant performs an operation by selecting the character input button image g15, the fixed phase input button image g16, and the pictograph input button image g17. Furthermore, in a case where the character input button image g15 is selected, the processing unit 202 of the terminals 20 displays an image of a software keyboard on the display unit 203.

The acquisition unit 301 determines whether information that is acquired is voice signals or text information. In a case where the information is determined as text information, the acquisition unit 301 outputs the text information, which is acquired, to the text correction unit 305 through the voice recognition unit 302 and the text conversion unit 303.

In this embodiment, even in a case where the text information is input as described above, the text information is displayed on the display unit 203 of the terminals 20.

As a result, according to this embodiment, even in a case where an input is text information, it is possible to attain the same effects as in the first embodiment.

Furthermore, a program for realization of all the functions or some of the functions of the conference support system 1 in the invention may be recorded on a computer-readable recording medium, and the program recorded on the recording medium may be read out to a computer system and may be executed therein to perform the entirety or a part of the processing executed by the conference support system 1. Furthermore, it is assumed that the “computer system” stated here includes hardware such as an OS and a peripheral device. In addition, it is assumed that the “computer system” also includes a WWW system including a homepage providing environment (or a display environment). In addition, the “computer-readable recording medium” represents a portable medium such as a floppy disk, a magneto-optical disc, a ROM, and a CD-ROM, and a storage device such as a hard disk that is embedded in the computer system. In addition, it is assumed that the “computer-readable recording medium” also includes a medium such as a volatile memory (RAM), which retains a program for a predetermined time, inside the computer system that becomes a server or a client in a case where the program is transmitted through a network such as the Internet or a communication line such as a telephone line.

In addition, the program may be transmitted from a computer system in which the program is stored in a storage device and the like to other computer systems through a transmission medium, or transmission waves in the transmission medium. Here, the “transmission medium”, through which the program is transmitted, represents a medium having a function of transmitting information similar to a network (communication network) such as the Internet and a communication line such as a telephone line. In addition, the program may be a program configured to realize a part of the above-described functions. In addition, the program may be a so-called differential file (differential program) capable of being realized in combination with a program that is recorded in advance in a computer system having the above-described functions.

What is claimed is:

1. A conference support system, comprising:
a plurality of terminals which are respectively used by a plurality of participants in a conference; and
a conference support device,
wherein each of the plurality of terminals includes
an operation unit that sets uttering intention, and
an own utterance notifying unit that notifies the other terminals of information indicating the uttering intention.

2. The conference support system according to claim 1,
wherein the own utterance notifying unit of the terminal transmits information indicating termination of the utterance to the conference support device when the utterance is terminated.

3. The conference support system according to claim 1,
wherein when receiving information indicating uttering intention of the plurality of participants from the plurality of terminals, a processing unit of the conference support device sets an utterer on the basis of a priority that is set in advance.

4. The conference support system according to claim 1,
wherein after receiving information indicating uttering intention of one of the plurality of participants, when receiving information indicating uttering intention of the other participants from the other terminals, the processing unit of the conference support device issues an alarm indicating that another participant is in utterance.

5. The conference support system according to claim 1,
wherein the conference support device includes an acquisition unit that acquires utterance and determines whether a content of the utterance is either voice information or text information, and
a voice recognition unit that recognizes the voice information, and converts the voice information into text information in a case where the content of utterance is voice information.

6. A conference support system, comprising:
a plurality of terminals which are respectively used by a plurality of participants in a conference; and
a conference support device,
wherein the conference support device includes,
a processing unit that does not permit utterance from the terminals other than a terminal from which information indicating uttering intention of one of the plurality of participants is received, and
each of the plurality of terminals includes,
an operation unit that sets information indicating uttering intention, and
an own utterance notifying unit that transmits the information indicating the uttering intention to the conference support device.

7. A program for a conference support device in a conference support system including a plurality of terminals which are respectively used by a plurality of participants in a conference, and the conference support device, the program allowing a computer of the conference support device to execute:
receiving information indicating uttering intention of each of the plurality of participants;
determining whether or not reception of the information indicating the uttering intention of one participant from one terminal and reception of the information indicating the uttering intention of the other participants from the other terminals overlap each other; and
not permitting the utterance from the other terminals in a case where the receptions overlap.
